(19) United States
(12) Patent Application Publication
(10) Pub. No.: US 2006/0083481 A1
(43) Pub. Date: Apr. 20, 2006

(54) Method for generating a playlist and the system for the same

(75) Inventor: Ming-Fon Yang, San-Chong City (TW)

Correspondence Address: KUSNER & JAFFE;HIGHLAND PLACE SUITE 310, 6151 WILSON MILLS ROAD, HIGHLAND HEIGHTS, OH, 44143, US

(73) Assignee: Ulead Systems, Inc.

(21) Appl. No.: 10/965,536

(22) Filed: Oct. 14, 2004

(51) Int. Cl. H04N 5/783

(52) U.S. Cl. 386/69; 386/70

(57) ABSTRACT

The present invention discloses a method for generating a playlist, which comprises: retrieving data of every video file stored in storing means; generating a video timeline based on the data, wherein the video timeline represents the video files arranged in order; setting at least one pair of beginning and end tags on the video timeline; creating a playlist by collecting all tags in that order; and storing the playlist in the storing means. With the present invention, users could edit a play sequence of a whole digital video disc in DVD-VR format by generating a playlist in a pretty easy and convenient way.

### RELATED APPLICATIONS

The present application refers to co-pending U.S. patent applications filed by the same assignee as the present application. The co-pending U.S. patent applications are cited herein as cross-reference applications, and are fully incorporated herein by reference. These co-pending U.S. patent applications are identified as follows: U.S. application Ser. No. 10/303,026 (U.S. Patent Pub. No. 2004/0101042A1) entitled “Method for shot change detection for a video clip” filed on Nov. 25, 2002, U.S. application Ser. No. 10/211,574 (U.S. Patent Pub. No. 2003/0147012A1) entitled “Method for detecting scene changes in compressed video data” filed on Aug. 5, 2002, U.S. application Ser. No. 10/235,886 (U.S. Patent Pub. No. 2004/0046801A1) entitled “System and method for constructing an interactive video menu” filed on Sep. 6, 2002, and U.S. application Ser. No. 10/885,728 entitled “Method and System of Visual Content Authoring” filed on Jul. 8, 2004.

### FIELD OF THE INVENTION

This invention is relative to a method for generating a playlist of the video files on a storing medium like DVD.

### BACKGROUND OF THE INVENTION

Thanks to the popularity of digital video devices and optical storage media (e.g. digital still/video camera, VCD burner, DVD recorder, VCD, DVD, etc), people now can easily shoot, record, and store digital videos at any time. In many cases, the videos will then be edited to fit various purposes such as removing unnecessary portions, combining videos, changing playback sequence and so on. And these editing tasks can be done through a video-editing program on a computer.

Though the large storage capacity of a DVD makes it ideal for storing high-quality movies, burning a DVD is relatively slow compared to burning a CD. In addition, users may not be able to use up the total disc space at one time. So, if users want to store more videos or edit existing contents onto the same DVD, this disc should be re-editable. Traditionally, re-editing a DVD is pretty time-consuming because all videos have to be imported to your computer and go through the burning process again. To solve the problem, a format called DVD-VR (Video Recording) is introduced to the market.

The DVD-VR format provides an editable playlist for users to manipulate the playback sequence of the videos on a DVD. Though set-top home DVD recorders provide simply playlist editing, many users usually turn to a DVD-VR software program for more sophisticated and powerful editing. With a software program like this, users select a video in the DVD first and set some pairs of beginning and ending tags in the video. A playlist is then created by collecting the tags. Hence, the video section between each pair of beginning and ending tags can be played continuously.

However, if users want to generate a playlist for each video stored on a DVD, the process has to be repeated based on the number of videos. That is, users can handle only one video at a time. This tedious and time-consuming process can easily turn users down. It would be nice if a more efficient way to generate a playlist for a whole DVD is available.

### SUMMARY OF THE INVENTION

In view of the above problem, the present invention therefore provides the following methods and a system to generate a playlist. So, users can edit the playback sequence of all data (files) on an entire DVD by generating a playlist in an easy and convenient way.

In order to achieve the objects of the present invention, an embodiment provides a method for generating a playlist of a whole DVD which having one or more video files stored therein. The playlist generating method comprises the step of retrieving data of video files stored in storage. Subsequently, a video timeline based on the data of the video files is generated, wherein the video timeline represents the video files arranged in order, followed by setting tags on the video timeline. A playlist is next created by collecting all tags corresponding to the predetermined order. The following procedure includes a step of storing the playlist in the storage. The storage may include a DVD in DVD-VR format, a Blue-ray disc, a SD card, a hard disc, etc.

In one embodiment, a system for generating a playlist for a DVD which having one or more videos stored therein is provided to achieve the objects of the present invention. The playlist generating system comprises: a process unit and a buffer is coupled to the process unit for temporarily storing the playlist and the data of one or more video files. Storage is coupled to the buffer for storing the video files and the playlist. A user interface couples to the process unit and the user interface including a video timeline representing video files which are arranged according to the data thereof, wherein the user interface enables a user to set tags on the video timeline. A displayer is coupled to the process unit for displaying the user interface. The process unit is employed for collecting tags in order to create the playlist in the buffer. The storage may include a DVD in DVD-VR format, a Blue-ray disc, a SD card, a hard disc, etc.

Further, the present invention provides a method for edit video files, which comprises: retrieving data of the video files in storage; generating a video timeline based on the data of the video files, wherein the video timeline represents the video files arranged in order; setting at least one pair of tags on the video timeline; and deleting the portions outside each pair of tags of the video files stored in the storage. The storage may include a DVD-VR disc, a CD-RW disc, a DVD−RW disc, a DVD+RW disc, a Blue-ray disc, a hard disc, flash memory, etc.

In another embodiment, a storage medium presented in the present invention comprises: a retrieving module for retrieving data of video files stored in storing means; a generating module for generating a video timeline represent the video files arranged according to the data thereof, wherein the data are retrieved by the retrieving module; a setting module for setting tags on the video timeline generated by the generating module; and a creating module for creating a playlist by collecting all tags in order and storing the playlist in the storing means. The storage medium may include a DVD, a compact disc, a Blue-ray disc, a hard disc, flash memory, etc. Besides, the storing means may include a DVD-VR disc, a CD-RW disc, a DVD−RW disc, a DVD+RW disc, a Blue-ray disc, a hard disc, flash memory, etc.

### BRIEF DESCRIPTION OF THE DRAWINGS

FIG. 1 is a flow diagram showing the procedure of the method in according with one embodiment of the present invention.

FIG. 2 is a flow diagram showing the procedure of scene change detecting in according with one embodiment of the present invention.

FIG. 3 is a block diagram of the system of the present invention.

FIG. 4 is a flow diagram showing the procedure of the method in according with another embodiment of the present invention.

FIG. 5 is a storage medium of the present invention.

### DETAILED DESCRIPTION OF THE PREFERRED EMBODIMENTS

Referring now to the drawings wherein the showings are for the purpose of illustrating the preferred embodiments of the present invention only, and not for the purpose of limiting same.

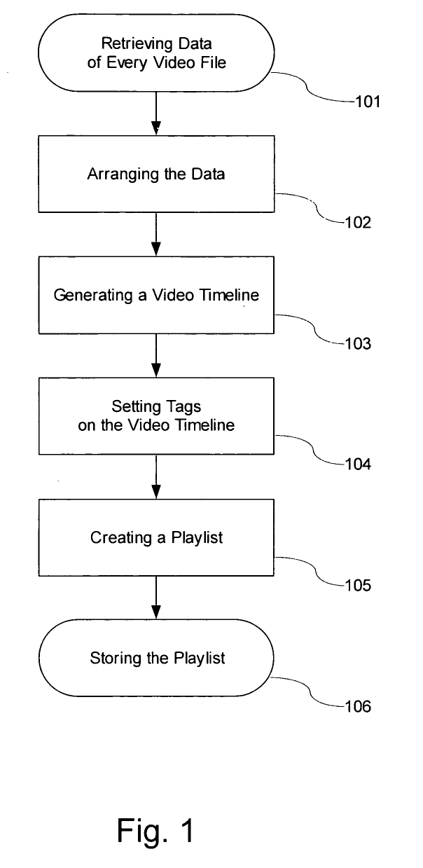

In the light of one embodiment of the present invention, a method for generating a playlist is disclosed. According to FIG. 1, in step 101, the data of at least two (in some cases, maybe every) video files stored in storage are retrieved. In this embodiment, the data architecture may include the file size code, the file name code, the last-modified time code, or the play length code of each video file. It should be appreciated that various kinds of data could be retrieved in the present invention, and the examples above is cited merely for the purpose of description, not used to limit the scope of the present invention. In following step 102, the retrieved data are arranged in order according to the content therein. Since the data may include various kinds of information about the video files stored in the storage, the arrangement could depend on any one of the various kinds of information. In one embodiment of the present invention, the data are arranged according to the last-modified time code. Yet, in another embodiment of the present invention, a user could arrange these data on her/his own demand. After the data are well arranged, a video timeline is generated in the step 103. In a preferred embodiment, the video timeline represents every video file stored in the storage, that is, all video files in the storage are included in this video timeline and well arranged. With this video timeline, the user may edit plural video files as a whole, therefore a user-friendly means is provided. Next, in step 104, in order to edit all video files, the users just have to set tags on the video timeline 104. In one embodiment, the tags are set in pairs, and the portions between each pair of tags would be reserved. Through colleting these tags, the play sequence desired by the user would be recorded. Therefore, a playlist is created in step 105 since it stands for the preferred play sequence. After the creation of play sequence by collecting all tags, in step 106, the playlist would be stored into the storage which contains the video files.

In the preferred embodiment of this invention, the storage comprises but not limited to a digital video disc (DVD) in DVD-VR format. A Blue-ray disc, a SD card, and other storing means that is adapted to the function of the playlist could also be adapted in the present invention.

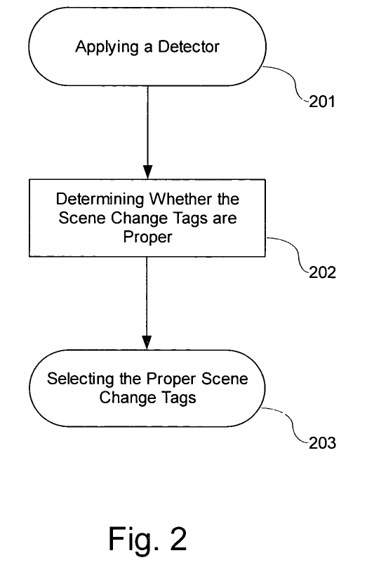

Except by the user, the tags may even be set automatically. Referring to FIG. 2, in step 201, when the video timeline is generated, a detector may be applied to set scene change tags on the video timeline. The technique about scene change detecting has been disclosed in the U.S. patent application Ser. No. 10/303,026 entitled “Method for shot change detection for a video clip” and U.S. patent application Ser. No. 10/211,574 entitled “Method for detecting scene changes in compressed video data,” which are both filed by the same assignee of the present application. The co-pending application is incorporated herein for reference. In order to avoid obscuring the aspect of the present invention, the details of the scene change detecting technique is omitted here. After the scene change tags are set, users may need to check them and determine whether they are proper or not in the following step 202. Proper scene change tags should be selected in step 203. Such procedure is optional depending on the demand of the users.

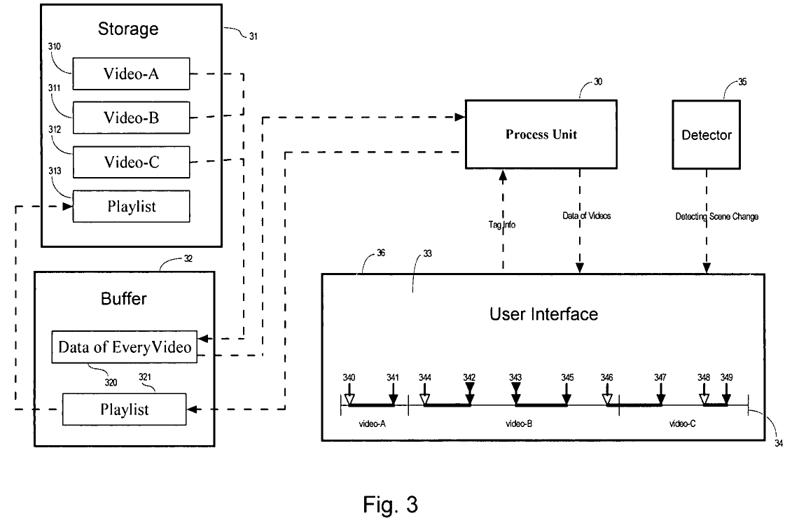

The present invention also provides a system for generating a playlist. Referring to FIG. 3, this system comprises a process unit 30, storage 31, buffer 32, a user interface 33, and a displayer 36. In this embodiment, the storage 31 includes three video files stored therein, which are video-A 310, video-B 311, and video-C 312. It is appreciated that the number of the video files are various, that is, any number of video files could be stored in the storing means if not exceeding the capacity of that storage. The buffer 32 is coupled to the process unit 30 to store the data 320 of every video file in the storage 31. For example, the data may comprise but not limited to the file size code, the file name code, the play length code, or the last-modified time code. In another embodiment of the present invention, the data may further comprise other information of the video files. With the data in the buffer 31, the video timeline 34 could be generated. In this embodiment, the process unit 30 treats the data and subsequently creates the video timeline. This video timeline 34 is contained in the user interface 33 and presents the video files in the storage 31. The user interface 33 is coupled to the process unit 30. The arrangement of the order of these video files in the video timeline 34 depends on the data 320. In this embodiment, the representation sequence is made according to the file name code, but other data may be adapted to arrange the video timeline, such as the last-modified time code. Moreover, the user may even arrange the video timeline on her/his own demand. The user interface 33 enables the user to set at least one pair of beginning and end tags on the video timeline 34. In one embodiment of the present invention, the tags could be set by a cursor controlled by a mouse or a writing pad, and the beginning tags are respectively designated with reference numbers 340, 344, 346, and 348. The vocal control is also available. Each beginning tag has a corresponding end tag, vice verse. These end tags are designated with reference numbers 341, 345, 347, and 349, respectively. According to FIG. 3, the portions between each pair of beginning and end tags are highlighted, and the highlighted parts are desired to be added in a play sequence.

In another embodiment of the present invention, the system may further comprise a detector 35 for detecting scene change point in every video file and automatically setting scene change tags on the video timeline 34. In FIG. 3, two scene change tags 342 and 343 are set on the video timeline 34, and the portion between tags 342 and 343 is undesired. It is appreciated that the scene change technique has been disclosed in the U.S. patent application Ser. No. 10/303,026. Moreover, whether the scene change tags are proper and the portions between the scene change tags are desired may by determined by the user through the user interface 33.

The displayer 36 is coupled to the process unit 30 to display the user interface 33. Such displayer includes a CRT monitor, LCD monitor, projector, plasma display panel, or other device capable of showing the video timeline and the tags thereon.

Since the playlist record the desired play sequence of the video files in the storage 31, such playlist can be made by collecting all tags on the video timeline 34 by the process unit 30. The created playlist 321 is stored in the buffer temporarily and then written into the storage 31. Next time when the user wants to watch the video files in the storage 31 in the desired play sequence, the playlist 313 could be read to show related information.

In the preferred embodiment of this invention, the storage comprises a digital video disc in DVD-VR format. However, the present invention is not limited to such kind of storage. A Blue-ray disc, a SD card, and other storing means that is capable of adapting the function of the playlist could also be adapted in the present invention.

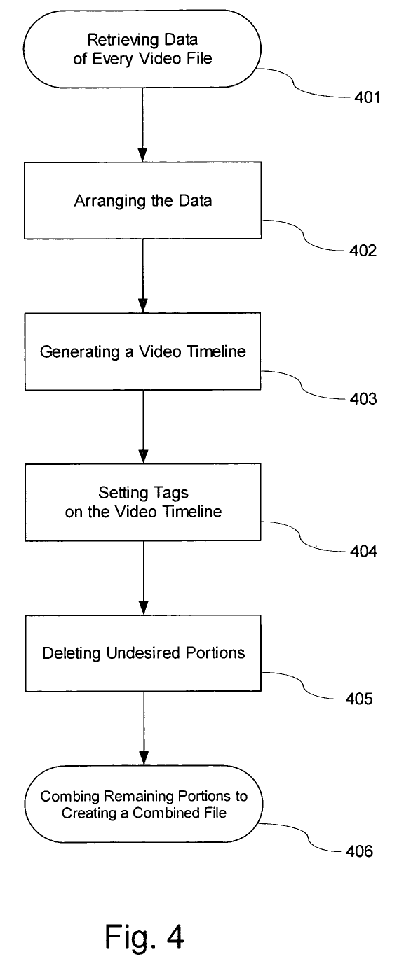

According to another aspect of the present invention, a method for editing video files is provided. Now referring to FIG. 4, the presented method is similar to the method mentioned above except that no playlist is generated, the undesired portions are deleted in step 405, and the desired portions are combined as a new combined video file in step 406.

In step 401 the data of every video file stored in storage are retrieved. In this embodiment, the data may include the file size code, the file name code, the last-modified time code, or the play length code of video files. It should be appreciated that various kinds of data could be retrieved in present invention, and the examples above is cited merely for the purpose of description. In step 402, the retrieved data then are arranged in order according to the code therein. Since the data may include various kinds of information about the video files stored in the storage, the arrangement could depend on any of them. In one embodiment of the present invention, the data are arranged according to the last-modified time code. Yet, in another embodiment of the present invention, a user could arrange these data on her/his own. After the data are well arranged, a video timeline is generated in step 403. The video timeline represents every video file stored in the storage, that is, all video files in the storage are included in this video timeline and well arranged. With this video timeline, the user may edit plural video files as a whole, therefore a user-friendly way is provided. To edit all video files, the user just have to set one or more pair of beginning and end tags on the video timeline 404, and the portions between each pair of the beginning and end tags would be reserved. That is to say, the other portions would be deleted in step 405. Furthermore, the reserved portions may be combined to create a new combined video file in step 406.

The storage in this embodiment may comprise a digital video disc in DVD-VR format. However, the present invention is not limited to such kind of storage. A Blue-ray disc, flash memory or a hard disc could also be adapted in the present invention.

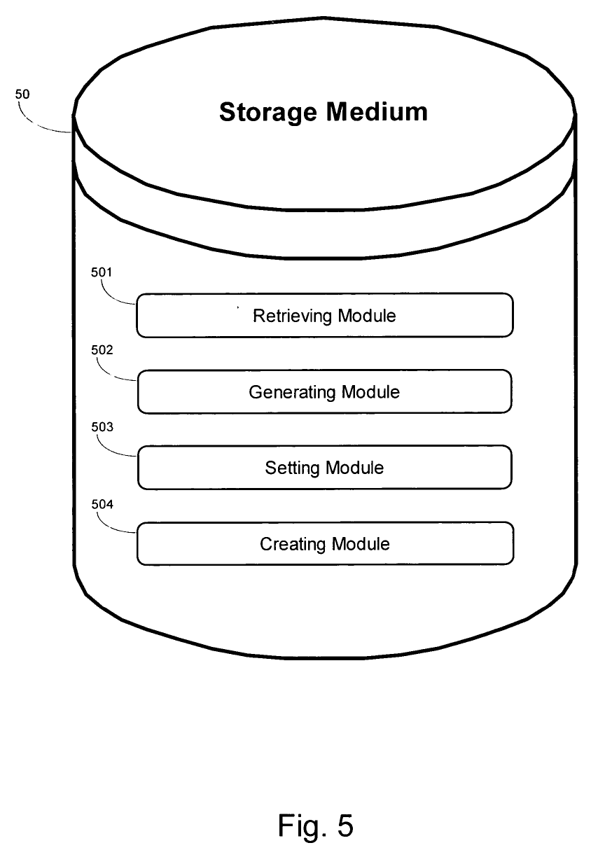

According to yet another aspect of the present invention, as shown in FIG. 5, a storage medium 50 is provided. Such storage medium 50 may comprise a floppy disc, flash memory, a compact disc (CD), a digital video disc (DVD), a hard disc, random-access memory (RAM), and etc. In other words, any device capable of storing data should be cover by the storage medium 50 of the present invention.

In the storage medium 50, several modules are included. These modules are operable to generate a playlist of every video in the storing means. This storage medium 50 comprises a retrieving module 501, a generating module 502, a setting module 503, and a creating module 504. In one embodiment of the present invention, these modules may be computer programs or software modules with specific functions. The retrieving module 501 retrieves the data of every video file stored in the storing means. With these data, the generating module 502 then generates a video timeline representing every video file in order, and the video files represented in the video timeline are arranged according to the data thereof. The data retrieved by the retrieving module 501 may comprise the file size code, the file name code, the last-modified time code, or the play length code of video files. It should be appreciated that various kinds of data could be retrieved in present invention, and the examples above is cited merely for the purpose of description. In one embodiment of the present invention, the arrangement could depend on the last-modified time code or the operation of a user. The setting module 503 then sets at least one pair of beginning and end tags on the video timeline. These tags may be set automatically or by the operation of the user. For example, a detector could be applied to set tags on certain scene change points. Besides, the user is still able to add or cancel the tags on the video timeline by using the mouse or the other cursor controlling device. Finally, by collecting the tags, the creating module 504 can create a playlist and then write it into the storing means.

In the preferred embodiment of this invention, the storing means comprises a digital video disc in DVD-VR format. However, the present invention is not limited to such kind of storing means. A Blue-ray disc, a SD card, and other storing means providing the function of the playlist could also be adapted in the present invention.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

We claim:

1. A method for generating a playlist, which comprises:
retrieving data of video files stored in storage;
generating a video timeline based on said data, wherein said video timeline represents said video files arranged in order;
setting tags on said video timeline;
creating said playlist by collecting all said tags in said order; and
storing said playlist in said storage.

2. A method as set forth in claim 1, wherein said video files represented in said video timeline is arranged according to said data which comprise a file size code, a file name code, a play length code, or a last-modified time code of said video files.

3. A method as set forth in claim 2, wherein said data are arranged according to said last-modified time code.

4. A method as set forth in claim 1, which further comprises:
applying a detector to detect scene change points in said video files and set scene change tags at said scene change points on said video timeline; and
selecting some of said scene change tags.

5. A method as set forth in claim 1, wherein said storage comprises a digital video disc in DVD-VR format.

6. A method as set forth in claim 1, wherein said storage comprises a SD card.

7. A method as set forth in claim 1, wherein said storage comprises a Blue-ray disc.

8. A system for generating a playlist, which comprises:
a process unit;
a buffer coupled to said process unit;
storage coupled to said buffer for storing video files and said playlist;
a user interface coupled to said process unit and said user interface including a video timeline representing said video files, wherein said user interface enables a user to set tags on said video timeline; and
a displayer coupled to said process unit for displaying said user interface;
wherein said process unit is employed for collecting said tags in order to create said playlist in said buffer.

9. A system as set forth in claim 8, wherein said video timeline is disposed according to last modified time.

10. A system as set forth in claim 8, which further comprises a detector for detecting scene change points in said video files and setting scene change tags at said scene change points on said video timeline.

11. A system as set forth in claim 8, wherein said storage comprises:
a digital video disc in DVD-VR format; and
a disc burner for writing said playlist into said digital video disc in DVD-VR format.

12. A system as set forth in claim 8, wherein said storage comprises:
a SD card; and
a card reader for reading and writing said SD card.

13. A system as set forth in claim 8, wherein said storage comprises:
a Blue-ray disc; and
a Blue-ray disc burner for writing said playlist into said Blue-ray disc.

14. A method for edit video files, which comprises:
retrieving data of said video files stored in storage;
generating a video timeline based on said data, wherein said video timeline represents said video files arranged in order;
setting at least one pair of tags on said video timeline; and
deleting portions outside each said pair of tags of said video files stored in said storage.

15. A method as set forth in claim 14, wherein said video timeline is arranged according to said data which include a last-modified time code.

16. A method as set forth in claim 14, wherein said storage includes a digital video disc in DVD-VR format, a compact disc, a Blue-ray disc, a hard disc, or flash memory.

17. A method as set forth in claim 14, which further comprises:
combing remaining portions of said video files in said order to create a combined video file in said storage.

18. A storage medium comprises:
a retrieving module for retrieving data of video files stored in storing means;
a generating module for generating a video timeline representing said video files arranged according to said data thereof, wherein said data are retrieved by said retrieving module;
a setting module for setting tags on said video timeline generated by said generating module; and
a creating module for creating a playlist by collecting all said tags in order and storing said playlist in said storing means.

19. A storage medium as set forth in claim 18, wherein said data comprise a file size code, a file name code, a play length code, or a last-modified time code of said video files.

20. A storage medium as set forth in claim 19, wherein said video timeline is disposed according to said last-modified time code.

21. A storage medium as set forth in claim 18, wherein said storing means comprises a digital video disc in DVD-VR format.

22. A storage medium as set forth in claim 18, wherein said storing means comprises a SD card.

23. A storage medium as set forth in claim 18, wherein said storing means comprises a Blue-ray disc.
